(19) United States
(12) Patent Application Publication
(10) Pub. No.: US 2024/0296373 A1
(43) Pub. Date: Sep. 5, 2024

(54) Executing a Machine-Trained Model using Selectively Streamed Model Weights

(71) Applicant: Microsoft Technology Licensing, LLC, Redmond, WA (US)

(72) Inventors: Eric Chris Wolfgang SOMMERLADE, Oxford (GB); Marcelo GENNARI DO NASCIMENTO, London (GB); Mohsen FAYYAZ, Berlin (DE); Aleksandar UZELAC, Seattle, WA (US)

(73) Assignee: Microsoft Technology Licensing, LLC, Redmond, WA (US)

(21) Appl. No.: 18/116,282

(22) Filed: Mar. 1, 2023

(51) Int. Cl. G06N 20/00

(52) U.S. Cl. CPC G06N 20/00

(57) ABSTRACT

A technique implements a machine-trained model using resources of a local system. The technique operates by successively obtaining portions of model weights on an as-needed basis. The local system obtains at least some of the portions by downloading them from a source system in a streaming operation. The technique further successively executes parts of the machine-trained model in the local system using the portions of model weights that have been obtained, to provide an output result. An entirety of the model weights used by the local system to provide the output result is less than an entirety of the model weights available for download at the source system. The technique enables the local system to locally execute the machine-trained model without overburdening its local resources, and with reduced consumption of network resources.

### BACKGROUND

Large machine-trained models such as the GPT-3 model have billions of weights. For this reason, some user devices cannot feasibly implement these models using their local resources. More specifically, a typical user device may not have sufficient memory, storage, and/or processing capabilities to feasibly execute a large machine-trained model. It may likewise be impractical to download a large machine-trained model. To address this challenge, some prior systems implement large machine-trained models as online services, e.g., using collections of servers.

### SUMMARY

A technique is described herein for implementing a machine-trained model using resources of a local system. In some implementations, the technique operates by successively obtaining portions of model weights on an as-needed basis. The local system obtains at least some of the portions by downloading them from a source system in a streaming operation. The technique further successively executes parts of the machine-trained model in the local system as the portions of model weights are obtained, to provide an output result. An entirety of the model weights used by the local system to provide the output result is less than an entirety of the model weights available for download at the source system.

The technique enables the local system to locally execute the machine-trained model without overburdening its local resources, and with reduced consumption of network resources. Further, the process of running the machine-trained model at the local system reduces the risk that private information of a user will be jeopardized (compared to the case of running the machine-trained model at the source system).

In some implementations, the portions of model weights available at the source system are expressible as a hierarchical tree. The model weights used to provide the output result in the local system corresponds to part of the hierarchical tree that is less than an entirety of the hierarchical tree.

In some implementations, each portion of model weights includes transformation weights and decision weights. The local system uses the transformation weights to generate output embedding information based on input embedding information. The local system uses the decision weights to select a next part of the machine-trained model to be executed. The local system then downloads model weights associated with the next model part, if not already locally cached by the local system.

In some implementation, the local system retains at least some of the portions of model weights after they are downloaded and used in a session. The local system may reuse these portions in a future application of the machine-trained model without re-downloading them.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative execution framework for locally implementing parts of a machine-trained model at a local system by streaming portions of model weights from a source system.

FIG. 2 shows a first illustrative implementation of an execution component for implementing a part of the machine-trained model at the local system.

FIG. 3 shows a second illustrative implementation of an execution component for implementing a part of the machine-trained model at the local system.

FIG. 4 shows a single model path executed by the local system, corresponding to a single path through a more encompassing machine-trained model, the weights of which are available at the source system. FIG. 4 also shows details of an illustrative transformation component used in one of the execution components.

FIG. 5 show different ways of downloading portions of model weights from the source system.

FIG. 6 expresses the machine-trained model as a graph of nodes, in which each parent node has three or more child nodes.

FIG. 7 shows an implementation of the local system that includes a single computing device.

FIG. 8 shows an implementation of the local system that includes two or more computing devices.

FIG. 9 shows a training system for training the machine-trained model.

FIG. 10 shows an example of training performed by the training system of FIG. 9.

FIG. 11 shows a process that provides an overview of one manner of operation of the local system.

FIG. 12 shows a process that provides another overview of one manner of operation of the local system.

FIG. 13 shows computing equipment that, in some implementations, is used to implement the execution framework of FIG. 1.

FIG. 14 shows an illustrative type of computing system that, in some implementations, is used to implement any aspect of the features shown in the foregoing drawings.

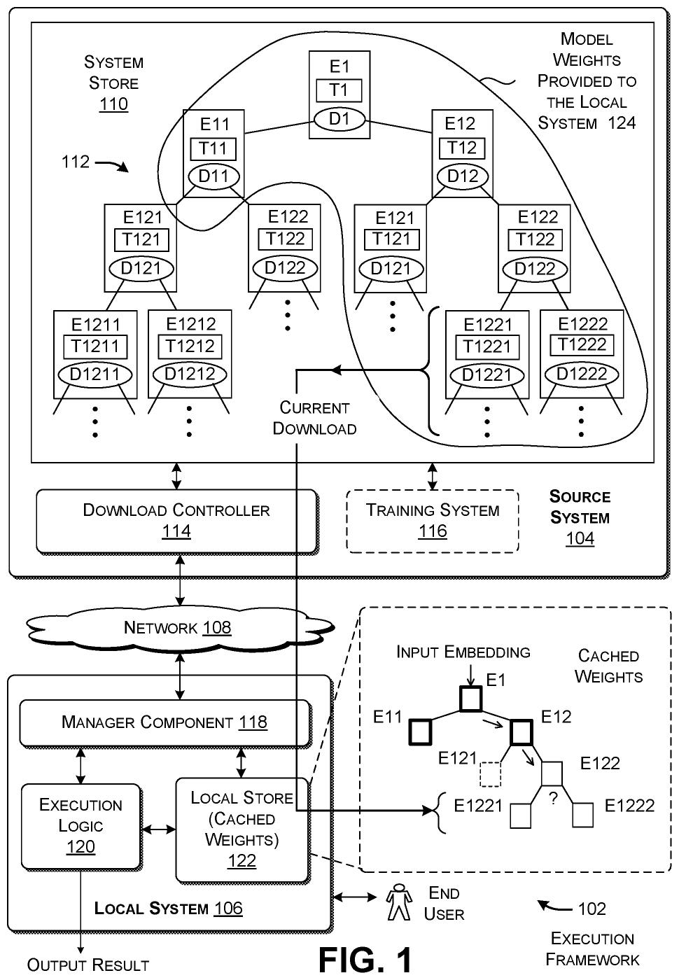

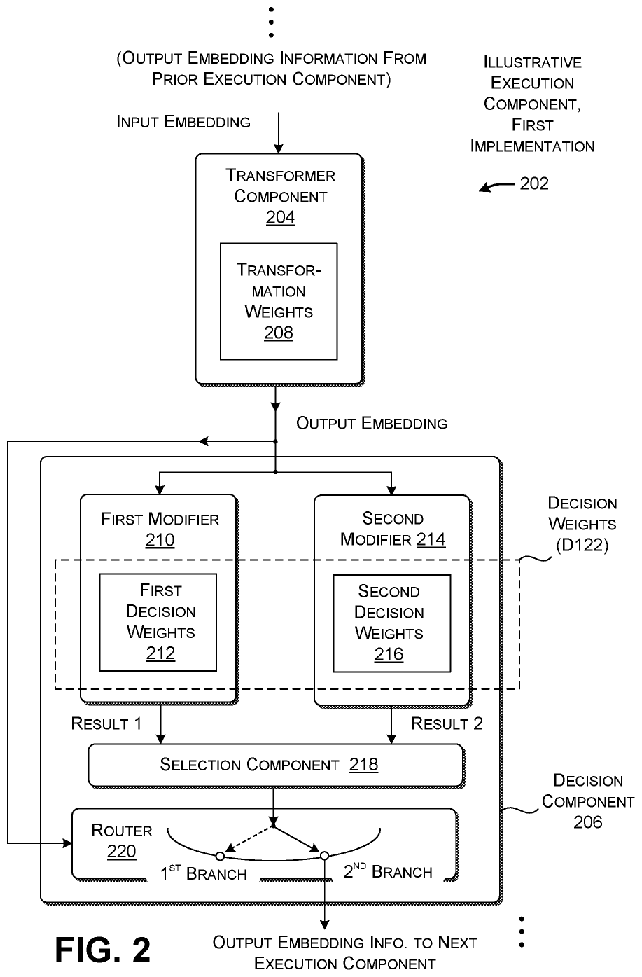

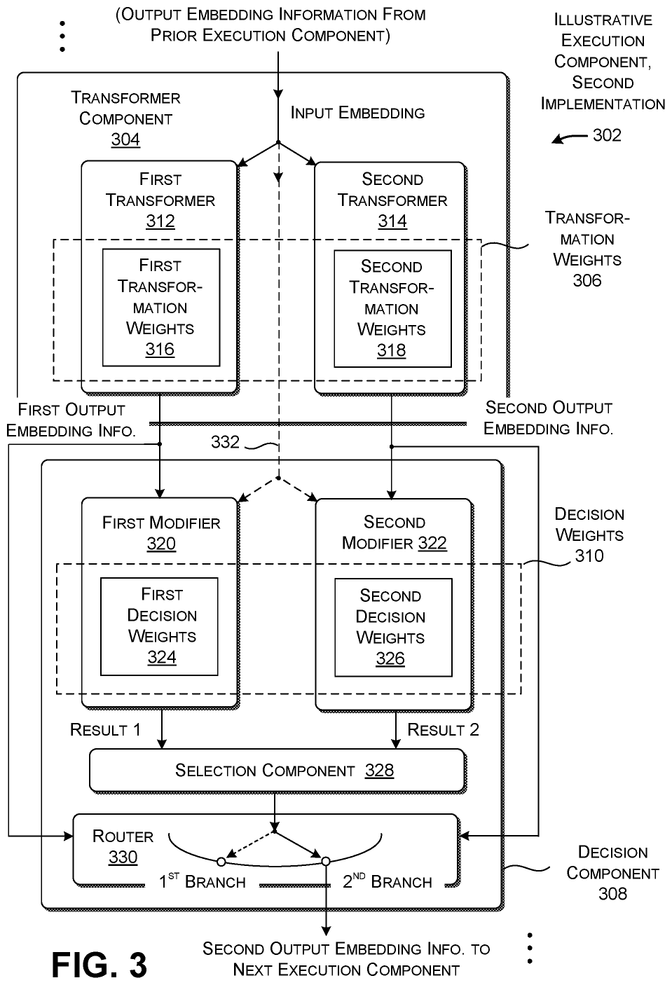

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

FIG. 1 shows an execution framework 102 that includes a source system 104 and a local system 106. The local system 106 is communicatively coupled to the source system 104 via a network 108 (such as the Internet). The source system 104 is implemented by one or more servers and/or other types of logic components. The local system 106 includes one or more computing devices and/or other types of logic components. For instance, in some implementations, the local system 106 includes a single user computing device of any type. In other implementations, the local system 106 includes a group of user computing devices coupled together via a local network (not shown). Although FIG. 1 only shows a single local system 106, the source system 104 provides service to plural local systems.

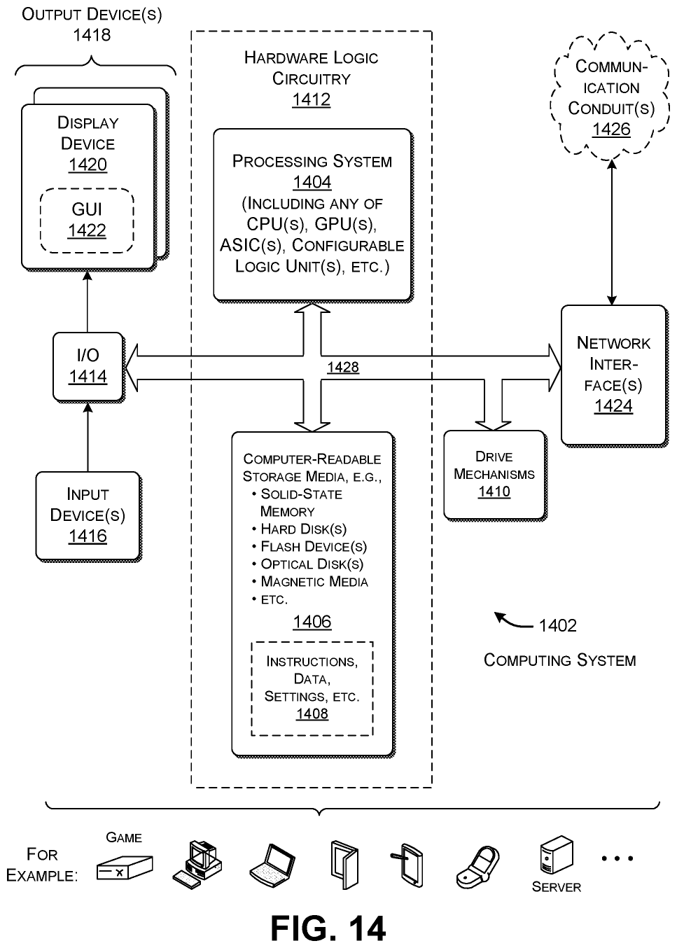

By way of terminology, a “machine-trained model” refers to logic for executing a task using machine-trained weights that are produced in a training operation. “Weights” is shorthand reference to parameter values. A “model part” refers to part of a machine-trained model that uses a particular portion of machine-trained weights. A “portion” of model weights refers to some of the machine-trained model weights used in the machine-trained model, but not all of the weights. In some contexts, terms such as “component,” “module,” “engine,” and “tool” refer to parts of computer-based technology that perform respective functions. FIGS. 13 and 14, described below, provide examples of illustrative computing equipment for performing these functions.

The source system 104 includes a system store 110 for storing a plurality of potions of model weights. In some implementations, the portions of model weights are expressible as a graph 112. The graph 112 includes nodes connected together by links. The nodes represent respective portions of model weights that are used in respective model parts. The links represent the temporal order in which the local system 106 is expected to use the model weights.

For example, the illustrative graph 112 shown in FIG. 1 takes the specific form of a hierarchy of nodes. The local system 106 is expected to first execute a model part that uses the model weights associated with parent node E1. The local system 106 is then expected to execute a model part associated with either node E11 or node E12, but not both. Assume that the local system 106 executes a model part associated with node E12. The local system 106 is then expected to execute a model part associated with node E121 or node E122, but not both. This process continues until the local system 106 executes a model part associated with a terminal (leaf) node of the tree, at which time the local system 106 provides a final output result.

According to illustrative implementations, the source system 104 specifically downloads portions of model weights from the source system 104 on an as-needed basis, as it executes successive model parts of the machine-trained model. This operation is referred to herein as the streaming of model weights. Note that the source system 104 only executes the model parts associated with one path through the hierarchical tree. This means that the local system 106 is only expected to download some of the model weights available at the source system 104, not all of the weights.

By virtue of the above-described manner of operation, the local system 106 is able to execute relatively large machine-trained models in a resource-efficient manner, compared to a base case in which the local system 106 downloads a complete machine-trained model and then runs it. More specifically, the streaming operation does not overburden the storage resources of the local system 106 because the local system 106 is not expected to store a complete copy of the machine-trained model's weights at any given time. The streaming operation does not overburden the memory resources of the local system 106 because the local system 106 is not expected to load a large amount of model weights at any given time. The streaming operation does not overburden the processing resources (including central processing units (CPUs), graphics processing units (GPUs), and neural processing units (NPUs)) of the local system 106 because the local system 106 is not expected to execute large parts of the machine-trained model at the same time. Further, the streaming operation enables the local system 106 to more quickly begin running a machine-trained model, compared to the base case in which all of the model weights are downloaded over the network 108 prior to execution (which may require a significant amount of load time).

Note that a conventional machine-trained model may have fewer weights compared to all of the weights stored in the system store 110. To repeat, however, the local system 106 only downloads some, not all, of these weights, depending on the single path taken through the hierarchy of nodes. Further, the local system 106 is able to obtain and consume portions of these weights on an as-needed basis, and optionally discard them thereafter. This enables the local system 106 to overall consume a large machine-trained model in a more resource-efficient manner than traditional machine-trained solutions.

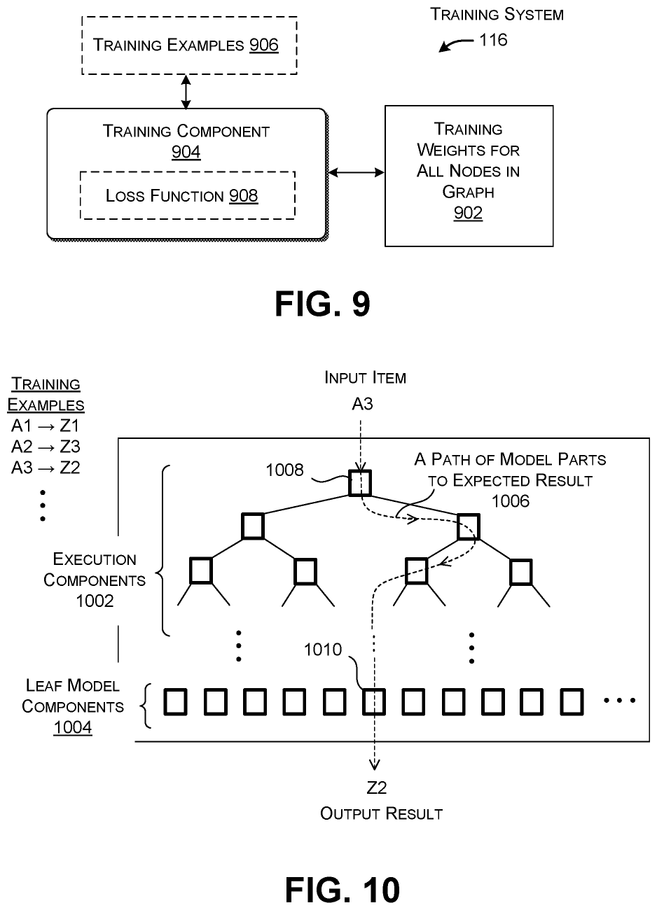

Continuing with the explanation of FIG. 1, the source system 104 includes a download controller 114 for serving portions of model weights to the local system 106 upon request by the local system 106. The source system 106 also hosts a training system 116 for producing the model weights; alternatively, the source system 106 interacts with a separately-implemented training system 116. Further details regarding one implementation of the training system 116 are provided below in connection with the explanation of FIGS. 9 and 10.

In some implementations, the local system 106 includes a manager component 118 for managing the execution of the machine-trained model. As part of its responsibilities, the manager component 118 interacts with the source system 104 to successively request portions of model weights. Execution logic 120 executes the machine-trained model. In some implementations, the execution logic 120 includes program instructions that implement the machine-trained model, e.g., by performing the computations required by the model.

A local store 122 stores the portions of model weights obtained from the source system 104. The term “local store” is intended to broadly encompass any storage resources used by the local system 106, and therefore encompasses both transient and non-transient storage resources (e.g., both random access memory resources and disk storage resources), unless a specific form of storage is explicitly specified below. For instance, the memory resources of the local store 122 store portions of the model weights during execution of the model parts corresponding to those portions. The non-transient storage resources of the local store 122 optionally store frequently-used portions of model weights on a longer-term basis, eliminating the need to download these portions upon each execution of the machine-trained model. More generally, a particular local environment will apply environment-specific rules in determining whether to commit a portion of model weights to non-transient (e.g., disk) storage.

The execution logic 120 executes a series of execution components in the course of running the machine-trained model. An execution component, in turn, is a model part that includes a transformer component and a decision component. The transformer component uses transformation weights to map an input embedding to an output embedding. The decision component uses decision weights to decide what execution component to invoke next. The decision component then routes the output embedding, produced by the transformer component, to the next execution component. Additional details regarding the construction and operation of illustrative execution components will be described below in connection with the explanation of FIGS. 2-4.

Each portion of model weights available in the system store 110 includes a particular instance of transformation weights (designated by the symbol “T”) and a particular instance of decision weights (designated by the symbol “D”). For instance, the node labeled E122 includes particular transformation weights T122 and particular decision weights D122.

Finally, FIG. 1 shows one manner of operation of the execution framework 102 at a particular juncture in the execution of a machine-trained model. Assume that the local system 106 has already executed the model parts associated with the nodes E1 and E12, and is currently in the process of executing the model part associated with node E122. At this juncture, there are only two possibilities: the decision component will either invoke the model part associated with node E1221 or node E1222. To expedite the execution of the machine-trained model, the manager component 118 proactively requests portions of model weights for both node E1221 and node E1222, even before the decision component has decided which portions are to be used. In some implementations, the manager component 118 thereafter purges the portion of model weights that were not used. Alternatively, the manager component 118 proactively downloads more than two portions of model weights, such as the model weights associated with the nodes E1221 and E1222 together with the model weights associated with the children of these nodes (not shown in FIG. 1). Alternatively, the manager component 118 waits until a decision has been made, and downloads the model weights for only the next selected model part (corresponding to either E1221 or E1222, but not both).

Assume that, at the current time, the local system 106 has obtained model weights associated with the collection of nodes 124 circled in FIG. 1. The local system 106 has not, and will not, obtain model weights associated with nodes E121, E122, E1211, E1212, etc. Further assume that the local store 122 obtains the model weights for nodes E1, E11, and E12 from local store 122 (e.g., from persistent storage of the local store 122), without re-downloading the model weights from the source system 104.

FIG. 2 shows one implementation of an execution component 202. Assume that the execution component 202 specifically uses the weights of node E122 in the source system 104. The execution component 202 includes a transformer component 204 and decision component 206.

The transformer component 204 uses transformation weights 208 (e.g., transformation weights T122) to map an inputting embedding to an output embedding. As used herein, an “embedding” or, equivalently, “embedding information,” represents information in numeric form, typically as a distributed vector. A distributed vector is a vector that expresses the meaning information using a combination of its values. This is in contrast to a one-hot vector in which each dimension of the vector is assigned a particular meaning. Except for the case of the first execution component, the input embedding originates from an upstream execution component, which produces the input embedding as an output embedding. As noted above, in some implementations, the transformer component 204 relies on transformer-based logic.

The decision component 206 includes a first modifier 210 for mapping the output embedding to a first result using first decision weights 212, and a second modifier 214 for mapping the output embedding to a second result using second decision weights 216. Together, the first decision weights 212 and the second decision weights 216 constitute the decision weights (e.g., D122) provided at the system store 110. In some implementations, each modifier (210, 214) uses any type of neural network to perform its function, such as a feed-forward neural network having any number of layers. A selection component 218 identifies the next model part to invoke based on the first and second results. The next model part may correspond to a next execution component. A router 220 sends the output embedding produced by the transformer component 204 to the selected downstream model part.

In some implementations, the selection component 218 makes a binary decision between a first routing path and a second routing path, e.g., by selecting the first routing path if the first result is greater in magnitude than the second result, and selecting the second routing path if the second result is greater in magnitude than the first result item. This is a “hard” multiplexing criterion, meaning that the selection component 218 effectively assigns a probability of zero to all routing paths that have not been selected. If the first result equals the second result, then the selection component 218 randomly chooses a routing a path, or always chooses the first routing path (or the second routing path), or makes a selection based on any other environment-specific rule.

In other implementations, the selection component 218 assigns probabilities to each candidate routing path, such that more than one candidate routing path may be assigned a non-zero probability. Here, the selection component 218 selects the routing path having the highest probability. The selection 218 can assign probabilities in various ways, such as by performing a normalized exponential function. A Softmax operation, for instance, converts a vector z of real numbers into a series of probabilities, each given by (exp(zᵢ/T))/(Σᵢ exp(zᵢ/T)), where zᵢ is an input number in the vector z and T is a temperature parameter (which may be set to 1.0).

FIG. 3 shows another implementation of an execution component 302. Like the case of FIG. 2, the execution component 302 includes a transformer component 304 that operates using transformation weights 306, and a decision component 308 that operates using decision weights 310. In the implementation of FIG. 3, the transformer component 304 includes a first transformer 312 and a second transformer 314. The first transformer 312 uses first transformation weights 316 to map an input embedding to a first output embedding. The second transformer 314 uses second transformation weights 318 to map the same input embedding into a second output embedding.

The decision component 308 includes a first modifier 320 and a second modifier 322. These modifiers (320, 322) may be implemented in the same manner as the modifiers (210, 214) of FIG. 2, e.g., using neural networks of any type. The first modifier 320 uses first decision weights 324 to map the first output embedding into a first result. The second modifier 322 uses second decision weights 326 to map the second output embedding into a second result. A selection component 328 chooses between a first routing path and the second routing path using the same logic as the selection component 218 of FIG. 2. If the first routing path is selected, a router 330 sends the first output embedding to the next model part (e.g., the next execution component) along this path. If the second routing path is selected, the router 330 sends the second output embedding to the next model part (e.g., the next execution component) along this path. The dashed line 332 feeding into the modifiers (320, 322) indicates that the modifiers (320, 322) may also optionally take into consideration the input embedding fed to the transformer component 304.

Note that the execution component 302 of FIG. 3 is reduced to the execution component 202 of FIG. 2 by: a) omitting the second transformer 314; b) directing the single output embedding of the first transformer 312 to the first modifier 320 and the second modifier 322; and c) instructing the router 330 to route the single output embedding to the selected routing path. The execution component 302 of FIG. 3 may improve the ability of chains of model parts to capture the meaning of an input embedding, compared to the execution component 202 of FIG. 2. However, the execution component 302 of FIG. 3 uses more weights than the execution component 202 of FIG. 2, which adds complexity to the training and execution of the machine-trained model.

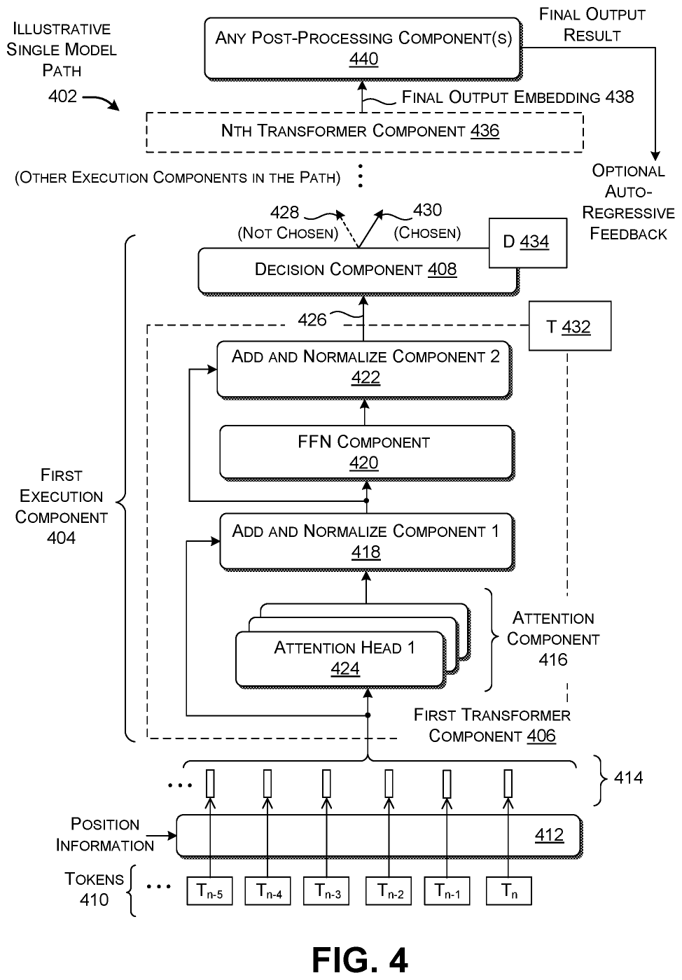

FIG. 4 shows a single model path 402 executed by the local system 106, corresponding to a single path through the more encompassing machine-trained model provided by the source system 104. The model path 402 maps initial input information to a final output result. The model path 402 includes, in part, a pipeline of execution components, including a first execution component 404. The first execution component 404 includes a transformer component 406 followed by a decision component 408. FIG. 4 also provides details regarding one way to implement the first transformer component 406. Although not specifically illustrated, other transformer components of the model path 402 have the same architecture and perform the same functions as the first transformer component 406 (but are governed by separate sets of weights).

The model path 402 commences with the receipt of input information from a source. In one implementation, the input information is a linguistic expression provided by a user or some other entity. The linguistic expression includes a series of linguistic tokens 410. As used herein, a “token” or “text token” refers to a unit of text having any granularity, such as an individual word, a word fragment produced by byte pair encoding (BPE), a character n-gram, a word fragment identified by the WordPiece algorithm, etc. To facilitate explanation, assume that each token corresponds to a complete word. The principles set forth herein, however, are not limited to the processing of text information; in other examples, the machine-trained model operates on any of: audio information, image information, video information, sensor-reading information, finance-related information, and so on, or any combination thereof.

Next, an embedding component 412 maps the sequence of tokens 410 into respective embedding vectors. For example, the embedding component 410 can produce one-hot vectors that describe the tokens, and can then map the one-hot vectors into the embedding vectors using a machine-trained linear transformation. The embedding component 412 then adds position information to the respective embedding vectors to produce position-supplemented embedded vectors 414. The position information added to each embedding vector describes the embedding vector's position in the sequence of embedding vectors.

The first transformer component 406 of the first execution component 404 operates on the position-supplemented input vectors 414. In some implementations, the first transformer component 406 includes, in order, an attention component 416, a first add-and-normalize component 418, a feed-forward neural network (FFN) component 420, and a second add-and-normalize component 422.

The attention component 416 performs attention analysis using the following equation:

$$attn ( Q , K , V ) = Softmax ( \frac{Q {K}^{T}}{\sqrt{d}} ) V . \qquad ( 1 )$$

The attention component 416 produces query information Q by multiplying the position-supplemented embedded vectors 414 (or, in some applications, just a last position-supplemented embedding vector associated with a last-received token) by a query weighting matrix W^{Q}. Similarly, the attention component 416 produces key information K and value information V by multiplying the position-supplemented embedding vectors by a key weighting matrix W^{K} and a value weighting matrix W^{V}, respectively. To execute Equation (1), the attention component 416 takes the dot product of Q with the transpose of K, and then divides the dot product by a scaling factor \sqrt{d}, to produce a scaled result The symbol d represents the dimensionality of Q and K. The attention component 416 takes the Softmax (normalized exponential function) of the scaled result, and then multiples the result of the Softmax operation by V, to produce attention output information. More generally stated, the attention component 416 determines how much emphasis should be placed on parts of the input information when interpreting other parts of the input information. In some cases, the attention component 416 is said to perform masked attention insofar as the attention component 416 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 4 shows that the attention component 416 is composed of plural attention heads, including a representative attention head 424. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 416 concatenates the output results of the attention component's separate attention heads, and then multiply the results of this concatenation by another weight matrix W^{O}.

The add-and-normalize component 418 includes a residual connection that combines (e.g., sums) input information fed to the attention component 416 with the output information generated by the attention component 416. The add-and-normalize component 418 then normalizes the output information generated by of the residual connection, e.g., by normalizing values in the output information based on the mean and standard deviation of those values. The other add-and-normalize component 422 performs the same functions as the first-mentioned add-and-normalize component 418.

The FFN component 420 transforms input information to output information using a feed-forward neural network having any number of layers. In some implementations, the FFN component 420 is a two-layer network that performs its function using the following equation:

$$FNN ( x ) = max ( 0 , {xW}_{fnn 1} + {b}_{1} ) {W}_{fnn 2} + {b}_{2} . \qquad ( 2 )$$

The symbols W_{fnn1} and W_{fnn2} refer to two weight matrices used by the FFN component 420, having reciprocal shapes of (d, d_{fnn}) and (d_{fnn}, d), respectively. The symbols b₁ and b₂ represent bias values.

As a whole, the first transformer component 406 produces an output embedding 426. The decision component 408 processes the output embedding 426 in the same manner previously described with reference to FIG. 2. This yields a first result and a second result. The decision component 408 chooses a first routing path 428 or a second routing path 430 based on its analysis of the first and second results. The first routing path 428 leads to a first next execution component (not shown), while the second routing path 430 leads to a second next execution component (not shown). Assume here that the decision component 408 chooses the second routing path 430.

Overall, the first transformer component 406 is implemented as a neural network that uses transformation weights T 432. The first decision component 408 is implemented as a neural network that uses decision weights D 434. The local system 106 downloads these weights (432, 434) from the source system 104 when needed, if not already locally stored in the local store 122. Other transformer components and other decision components use their own level-specific sets of transformation and decision weights.

In other examples, the machine model may insert a decision component after every p transformer components (p≥2), not necessarily after every transformer component. In this case, the two or more transformer components may be regarded as a single multi-block transformer component.

A final transformer component 436 in the model path 402 produces a final output embedding 438, and is not followed by a decision component. Instead, any kind of post-processing component 440 performs any post-processing operations on the final output embedding 438, to produce a final output result. In one case, for instance, the post-processing component 440 classifies the input information. In other case, the post processing component 440 predicts a next token to follow the input tokens 410, e.g., corresponding to a next word in a user's sentence that he or she is typing or speaking. The post-processing component 440 relies on any kind of processing logic, such as a feed-forward neural network having any number of layers, a Softmax operation, etc., or a combination thereof.

In some implementations, the machine-trained model 402 operates in an auto-regressive manner. To operate in this way, the post-processing component 440 uses the Softmax operation to predict a next token. The machine-trained model then appends the next token to the end of the sequence of input tokens 410, to provide an updated sequence of tokens. In a next pass, the machine-trained model processes the updated sequence of tokens to generate a next output token. The machine-trained model repeats the above process until it generates a specified stop token. Note, however, that different passes of this process may take different paths through the machine-trained model, which use different portions of model weights.

In a variation of the above operations, the machine-trained model additionally uses a beam-search component (not shown) to predict the n most likely next tokens, rather than a single most-likely output token. The machine-trained model explores a set of updated sequence of tokens, each produced by appending one of the next-token candidates to the existing sequence of input tokens 410. More specifically, in a beam search heuristic, the beam-search component selects a set of tokens having the highest conditional probabilities, e.g., by selecting the three tokens with the highest conditional probabilities when the beam width is set to 3. To compute the conditional probability of a particular token under consideration, the beam-search component identifies the search path through a search space that was used to reach the token under consideration. The beam-search component computes the conditional probability of the token under consideration based on a combination of the probabilities of the tokens along the search path.

To repeat, FIG. 4 illustrates a single path 402 through a machine-trained model, which is one path among many candidate paths. Thus, although FIG. 4 shows a single post-processing component 440, each terminal model part of the machine-trained model, corresponding to a leaf node, includes its own post-processing component.

Other implementations of the machine-trained model use other kinds of neural network architectures compared to the transformer-based architecture shown in FIG. 4. For instance, other implementations of the machine-trained model use a collection of convolutional neural networks (CNNS). Other implementations of the machine-trained model use a series of recurrent neural network (RNN) components. Each RNN component may use a collection of long short-term memory (LSTM) units.

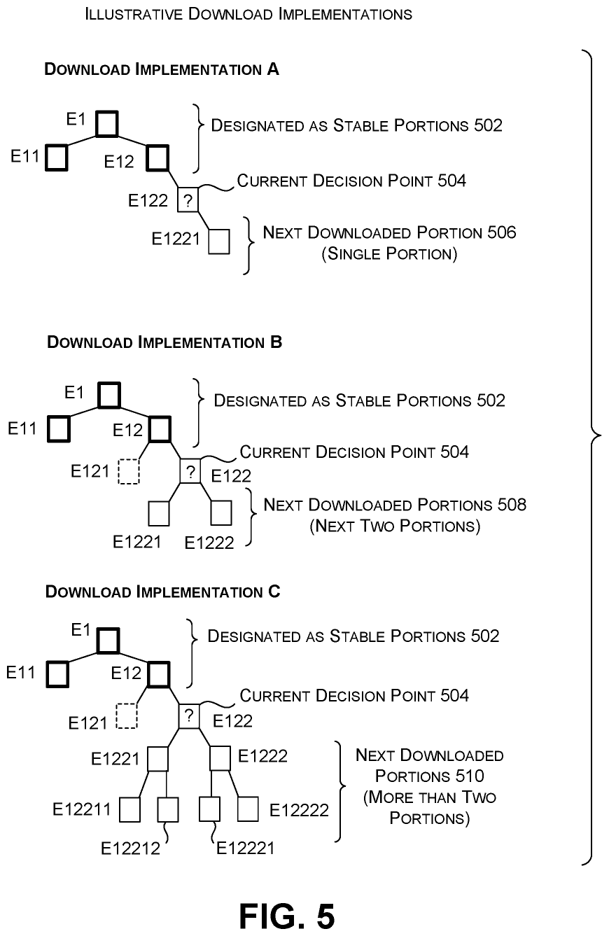

FIG. 5 shows different strategies performed by the manager component 118 to successively download portions of model weights. Each block shown in FIG. 4 corresponds to a portion of model weights. Each portion, in turn, includes an instance of transformation weights and decision weights. Note that some of the principles set forth below relate to decision-making as to whether to retain a portion of model weights on a temporary or more long-term basis. Different implementations may choose to implement temporary and long-term storage in different respective ways. In one case, temporary storage is implemented using random access memory, and long-term storage is implemented using some type of disk storage, but the principles set forth below are not limited to these particular implementations.

In implementation A, assume that the local system 106 already stores portions associated with nodes E1, E11, E12, and E122 in its local store 122. Further assume that the local system 106 has obtained the portions associated with the nodes E11, E11, and E22 in a prior download operation, rather than during the current execution of the machine-trained model. FIG. 1 collectively identifies these three portions as stable portions 502, indicating that the local system 106 has designated these portions 502 for long-term storage in the local store 122 (e.g., for storage in disk storage). Based on this designation, the manager component 118 will not remove these portions 502 from the local store 122 after the current execution of the machine-trained model. Because these portions 502 are already available in the local store 122 on a long-term basis, the local system 106 need not download them again from the source system 104. A model part that is executed based on already-stored model weights is referred to as a “local part.”

The manager component 118 can use different techniques to determine whether to designate a portion of model weights as stable, indicating that it should not be removed from the local store 122 after each use of the machine-trained model. In some cases, the manager component 118 designates the k top nodes of the hierarchical tree shown in FIG. 1 for storage in the local store 122 on a long-term non-transient basis, wherein k is a configurable environment-specific parameter. The premise underlying this strategy is that the top k nodes of the hierarchical tree are frequently invoked by virtue of the top-down manner in which model portions are used. In implementation A, k is 3 because the top three nodes are designated as stable. Alternatively, or in addition, the manager component 118 maintains a counter that counts how many times each portion of model weights is invoked. The manager component 118 instructs the local store 122 to designate a portion as stable when its frequency of use satisfies an environment-specific threshold value. In some implementations, the manager component 118 also adjusts the number of portions it designates as stable based on the storage capacity of the local system 106, the current processing load of the local system 106, and/or based on an environment-specific preference value.

Assume that the local system 106 has previously download the model portion associated with node E122 from the source system 104, stored it in memory, and, at a current point 504, is currently in the process of executing the execution component associated with this node. Further assume that the decision component of this execution component selects a particular routing path leading to a next execution component associated with node E1221. In implementation A, the manager component 118 only downloads a single portion 506 of model weights once its identity has been determined (that is, after the decision component has chosen a routing path). As such, the manager component 118 downloads the portion 506 associated with the node E1221, but not the portion corresponding to the node E1222 (which is associated with the non-selected routing path).

In implementation B, assume that the manager component 118 has already obtained portions associated with nodes E1, E11, E12, E121, and E122, and is currently in the process of executing the execution component associated with node E122. Here, the manager component 118 proactively obtains the portions 508 associated with nodes E1221 and E1222 before a routing decision is made. By doing so, the manager component 118 expedites execution of the machine-trained model. This is because the local system 106 is able to perform other operations in parallel with a download operation.

Assume that the decision component of the current execution component again selects the portion associated with node E1221. At this time, in some implementations, the manager component 118 discards (flushes) the model portion associated with node E1222 from memory, as it will not be used in the current execution of the machine-trained model. For similar reasons, assume that manager component 118 has already flushed the portion of model weights associated with node E121 from memory. Removing weights from memory is advantageous because it prevents the execution of the machine-trained model from overburdening the memory resources of the local system 106. Some implementations may also choose to store and remove portions of model weights from non-transient (e.g., disk) storage using the same principles described above.

Implementation C is the same as implementation B, except that, in implementation C, the manager component 118 proactively fetches the portions associated with the m next nodes in the hierarchical tree, where m is an environment-specific parameter value. In addition, the manager component 118 may dynamically vary the value m depending on the current processing load of the local system 106, taking into consideration both the magnitude and priority level of that load. Assume that the local system 106 is currently handling a heavy load; here, the manager component 118 may set the value m to 1, which reduces implementation C to the case of implementation A. Assume that, at another time, the local system 106 experiences a relatively low load; here, the manager component 118 may set the value of m to 6. Each particular environment defines what constitutes a heavy and light load. In the example of FIG. 5, the manager component downloads the next six portions 510, corresponding to nodes E1221, E1222, E12211, E12212, E12221, and E12222.

Assume that, as the flow progresses, the execution component for node E122 choses the routing path associated with the node E1221. Then, assume that the execution node E1121 chooses a routing path associated with the node E12212. As each routing path is selected, the manager component 118 optionally prunes (discards) the portions that have not been used, purging them from memory.

The above three examples were presented by way of illustration. Other implementations may use other strategies to orchestrate the downloading and storage of portions of model weights, and to manage the retention of stored portions of model weights.

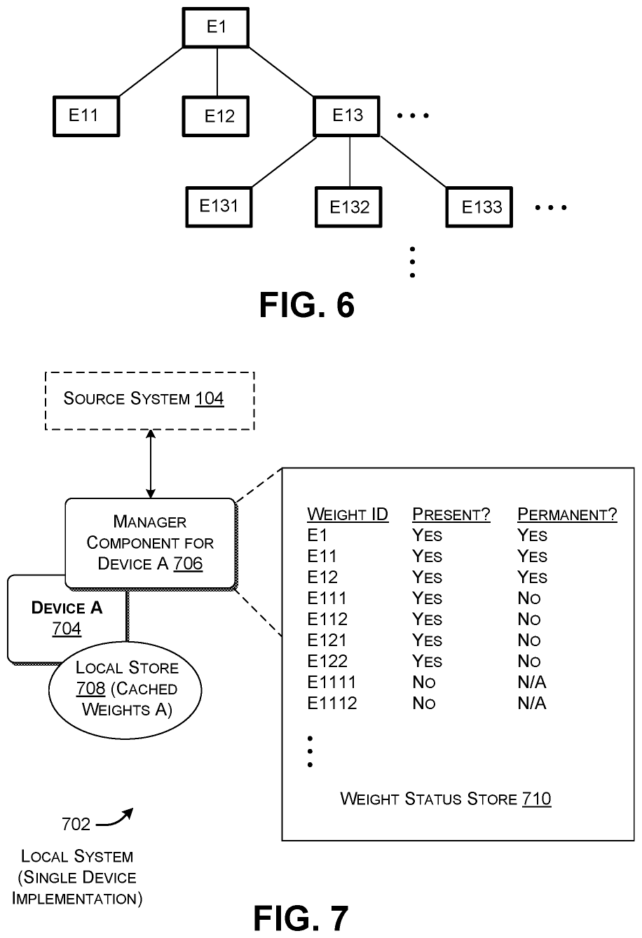

FIG. 6 shows an illustrative case in which each decision component chooses among three or more routing paths, leading to three or more next model parts. For instance, the decision component associated with the node E1 chooses from among at least the routing paths associated with nodes E11, E12, and E13. The decision component associated with node E13 chooses from among at least the routing paths associated with nodes E131, E132, and E133. Each decision can be “hard” or probabilistic (“soft”) in the same manner described above.

More generally, the machine-trained model discussed heretofore uses a graph organized as a hierarchical tree in which each parent node has two child nodes. In binary fashion, the execution component for each parent node chooses either one of its child nodes or the other. In other implementations, a machine-trained model can use another type of graph besides (or in addition to) a binary-branched hierarchical graph. For instance, in another implementation, some links the graph are bidirectional. In another implementation, some links in the graph may connect child nodes to parent or ancestor nodes.

Further, in some implementations, the decision components select among other options, not limited to choosing the next model part. For example, in other implementations, a decision component sets the number of transformer blocks that are used in a next model part, or adjusts any other hyper-parameter of the machine-trained model.

FIG. 7 shows a local system 702 of the execution framework 102 that uses a single computing device 704. The computing device 704 corresponds to any of a personal computing device (e.g., a desktop computing device), a handheld computing device of any type (a smartphone, tablet-type computing device, etc.), a game console, an intelligent appliance, a mixed-reality device, a dedicated home server, and so on. The computing device 704 includes a manager component 706 and local store 708 for performing the same functions described above. The computing device 704 obtains portions of model weights from the source system 104 in the manner previously explained.

In some implementations, the manager component 706 maintains or otherwise has access to a status store 710. The status store 710 indicates the portions of model weights that the local store 708 currently stores, and which portions it does not store. The status store 710 optionally indicates whether a portion stored in the local store 708 is designated for long-term (e.g., permanent or stable) storage. When a portion has this designation, the manager component 706 will not automatically flush it from the local store 708 after its current use. Again, the principles set forth here are agnostic to the manner in which a particular environment chooses to implement temporary and long-term storage.

In operation, when a next portion of model weights is needed, the manager component 706 consults the status store 710 to determine whether the local store 708 already stores it. If so, the manager component 706 obtains the portion from the local store 708. If not, the manager component 706 requests the portion from the source system 104.

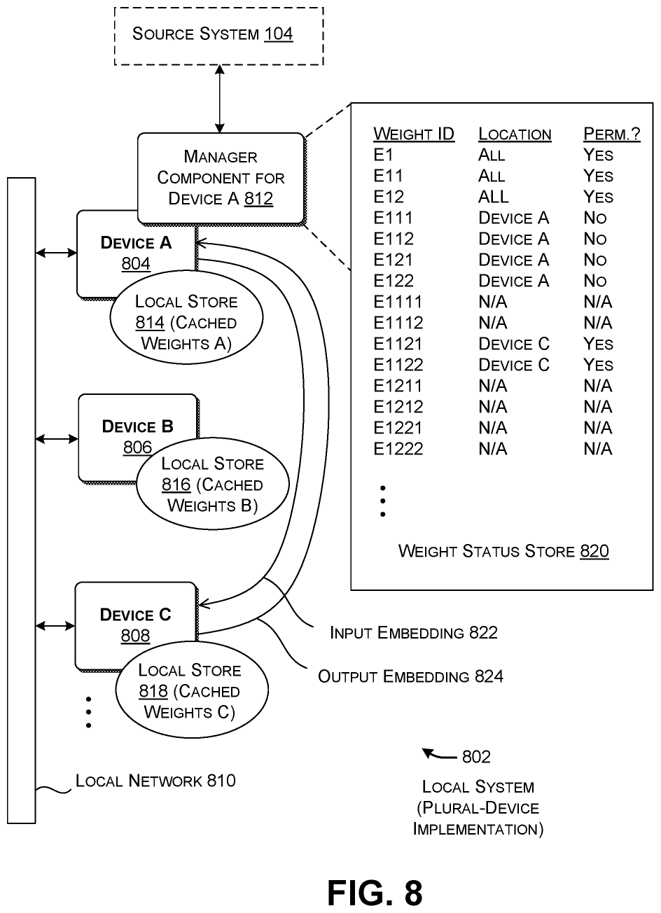

FIG. 8 shows a local system 802 in which plural computing devices play a role in the execution of a machine-trained model. In the example of FIG. 8, the local system 802 specifically uses at least three computing devices (804, 806, 808) communicatively coupled via a local network 810 (e.g., implemented using a router). Each computing device corresponds to any of the types of devices described above with respect to FIG. 7.

In some implementations, the local system 802 is configured to work in a master-slave mode, with the first computing device 804 serving as the master agent. The first computing device 804 includes a manager component 812 that is communicatively coupled to the source system 104. Although not shown, other computing devices (806, 808) optionally include their own respective manager components. Further, the computing devices (804, 806, 808) include respective local stores (814, 816, 818) for storing portions of model weights.

In some implementations, the manager component 812 serves as a master manager component that maintains or otherwise has access to a status store 820. The status store 820 indicates the location at which each portion of model weights is stored across the local system 802 (if in fact the portion is locally stored). For instance, the status store 820 indicates that all local stores (814, 816, 818) store the first portion E1 of model weights. The status store 820 indicates that the portion E111 of model weights is stored in only the local store 814 of the first computing device 804. The status store 820 optionally indicates whether a portion stored in the local system 802 is designated for long-term (e.g., permanent or stable) storage. When a portion has this designation, the manager component 812 will not automatically flush it from its local store(s) after its current use.

In operation, when a next portion of model weights is needed, the master manager component 812 consults the status store 820 to determine whether the local system 802 already stores the portion, and, if so, where the local system 802 stores the portion. Assume that the status store 820 indicates that the requested portion is stored in the local store 814 of the first computing device 804. Here, the master manager component 812 functions as before and obtains the portion from the local store 814.

In another case, assume that the status store 820 indicates that the requested portion is stored in the local store 818 of the third computing device 808. If so, the master manager component 812 sends an input embedding 822 to the third computing device 808. The input embedding 822 corresponds to the output embedding generated by the last-invoked transformer component. The master manager component 812 instructs the third computing device 808 to execute an execution component associated with the requested portion. The master manager component 812 further instructs the third computing device 808 to return an output embedding 824, corresponding to the output of the transformer component that is run by the third computing device 808.

Other implementations use other strategies to manage the computing devices (804, 806, 808). For instance, in another implementation, any of the computing devices (804, 806, 808) is able to assume the role of master computing device. Each computing device has access to the same global status store 820. Other implementations can use peer-to-peer strategies to manage interaction among the computing devices of a local system. In other implementations, an environment can establish different rules as to what constitutes an affiliated computing device for inclusion in a local system. For example, in an organizational environment, the local system may be regarded as the computing devices of some or all members of an organization.

Further, in some implementations, the local system 802 uses various environment-specific parameter values to govern its operation. For example, the local system 802 assigns preference values to each computing device. If two or more computing devices store a requested portion, then the local system 802 instructs the computing device with the highest preference value to execute the model part associated with the requested portion. Alternatively, or in addition, the local system 802 takes into account the current processing load experienced by each of the computing devices (804, 806, 808) in deciding which computing device is asked to execute a model part (presuming, again, that there are plural computing devices that are able to execute the model part). In some implementations, the master manager component 812 randomly chooses a computing device to execute the requested model part if there are no factors that establish that one computing device is more preferable than another computing device.

FIG. 9 shows one implementation of the training system 116 introduced in the explanation of FIG. 1. The training system 116 trains model weights 902 of the machine-trained model. In doing so, the training system 116 determines each portion of model weights in the hierarchical tree shown in FIG. 1. To repeat, each portion of model weights includes an instance of transformation weights used by a particular transformer component and an instance of decision weights used by a particular decision component.

The training system 116 includes a training component 904 for iteratively computing the model weights 902, based on a set of training examples 906 provided in a data store. In some implementations, each training example identifies an instance of input information together with an instance of ground-truth output information. The output information is qualified as “ground-truth” because it is considered by definition as correct. For a given training example, the training component 904 uses the machine-trained model in its current state to generate an instance of model-generated output information. The training component 904 uses a loss function 908 to assess the extent to which the model-generated instance of output information agrees with the ground-truth instance of output information. Based on this measure, the training component 904 updates the model weights 902 of the machine-trained model. The loss function 908 uses any measure of loss, such as by computing the cosine similarity between the ground-truth output information and the model-generated output information. In some cases, the training component 904 updates the model weights using gradient descent in combination with backpropagation.

FIG. 10 shows a specific example of a training operation performed for a collection of model parts. The model parts include a collection of hierarchically-connected execution components 1002. Each execution component, for instance, corresponds to the kind of execution component 202 shown in FIG. 2 or the execution component 302 shown in FIG. 3. Other model components 1004 assume the positions of leaf nodes in the machine-trained model. For instance, an illustrative model component corresponds to a terminal transformer component followed by a classification component or a prediction component. FIG. 10 also shows an illustrative path 1006 through the machine-trained model, starting with a particular instance of input information (which is generically labeled as information A3) submitted to a root execution component 1008, and terminating in a particular leaf model component 1010. The leaf model component 1010 generates an output result, which is generically labeled as output result Z2. Note that, for any given input item, the only model parts that play a role in delivering the output result are those model parts along the path 1006. This further means that, at any given time, only one leaf model component produces an output result; the others play no role and deliver no results.

One of the examples indicates that the input information A3 is indeed expected to terminate in the output result Z2. In the training operation, the training component 904 feeds the input information A3 into the machine-trained model that is being trained. Assume that the machine-trained model generates a result that does not match the ground-truth output result (Z2). In this case, the training component 904 adjusts the weights of the machine-trained model to penalize the configuration that has produced the faulty income. Alternatively, assume that the machine-trained model produces an output result that matches the ground-truth output result. In this case, the training component 904 adjusts the weights of the machine-trained model to reinforce the configuration of the machine-trained model that has produced the correct outcome.

Note that, other than the above-described matching of output results, the training component 904 does not dictate the course of the path 1006 between the input item and the output result (Z2) generated by the machine-trained model. Nor does the training component dictate the identity of the specific leaf model component that will deliver the correct result. Rather, the training component 904 automatically determines the course of the path 1006 over the course of its iterative training operation.

Further note that the training system 116 does not produce a machine-trained model that is equivalent to a single-path machine-trained model. For instance, the training system 116 produces model weights that take account for the fact that the machine-trained model has plural paths, which is not the case with a conventional single-path machine-trained model. The model weights produced by the training system 116 also include decision weights, which are not used in a conventional single-path machine-trained model.

In some implementations, the training system 116 uses one or more additional techniques to reduce the size of the machine-trained weights prior to downloading the weights to the local system 106. These techniques include knowledge distillation, pruning, and data compression. The training system 116 performs one or more of these techniques during initial training of the machine-trained model, during fine-tuning of the machine-trained model, and/or after the training of the machine-trained model.

Knowledge distillation uses a machine-trained teacher model to assist in training a smaller student model. In some implementations, the teacher model processes input examples to generate ground-truth output results. Knowledge distribution uses the ground-truth output results to train the student model. By this process, the knowledge of the more powerful, but more resource-intensive, teacher model is transferred to (or distilled in) the smaller and more resource-efficient student model.

Pruning operates to eliminate parameter values that have the least impact on the operation of a machine-trained model. For example, the pruning operation may remove (e.g., zero-out) weights used in the attention and/or feed-forward layers of the machine-trained model. Unstructured pruning specifically operates by eliminating the least impactful parameter values, without regard as to what parameter values are eliminated. Structured pruning operates by eliminating selected groups of weights, such as selected rows and/or columns of weights, and/or selected n×m blocks of weights. There are likewise different techniques for deciding which parameter values to remove. Magnitude pruning removes weights having magnitudes closest to zero. Movement pruning removes weights that move toward zero from one fine-tuning training iteration to the next.

Compression reduces the size of an existing machine-trained model. For instance, Principal Component Analysis (PCA) transforms parameter values to a space with fewer dimensions, compared to an original parameter values. Quantization reduces the size of the size of parameter values by changing the format used to express the parameter values, e.g., by converting floating point information into integer form. Illustrative quantized formats include TensorFloat32 (GF32), half-precision floating point, signed n-bit integer, etc.

General background information on the topic of model size reduction can be found in Xu, et al., “A Survey on Model Compression and Acceleration for Pretrained Language Models,” in arXiv archive, Cornell University, arXiv:2202.07105v2 [cs.CL], November 2022, 10 pages.

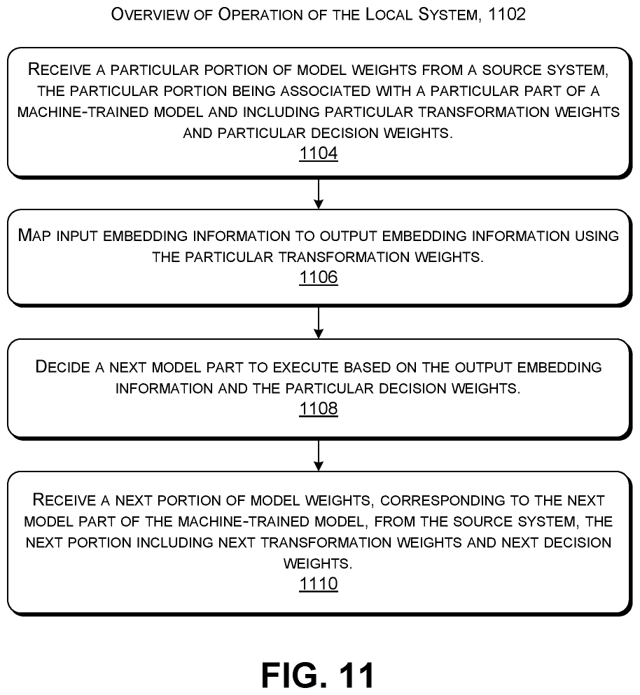

FIG. 11 shows a process 1102 that presents an overview of one manner of operation of the local system 106. In block 1104, the local system 106 receives a particular portion of model weights from a source system (e.g., the source system 104), the particular portion being associated with a particular part of a machine-trained model and including particular transformation weights and particular decision weights. In block 1106, the local system 106, maps input embedding information to output embedding information using the particular transformation weights. In block 1108, the local system 106 decides a next model part to execute based on the output embedding information and the particular decision weights. In block 1110, the local system 106 receives a next portion of model weights, corresponding to the next model part of the machine-trained model, from the source system, the next portion including next transformation weights and next decision weights.

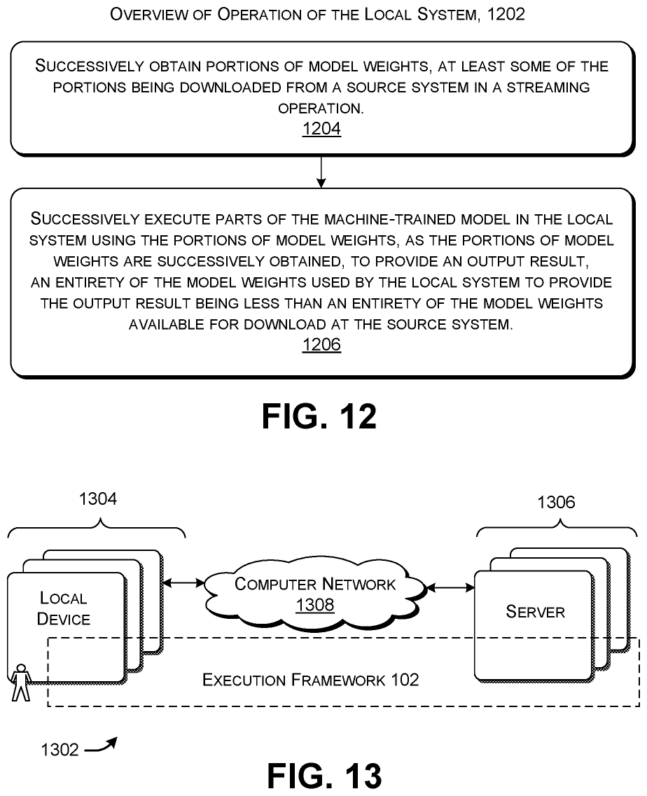

FIG. 12 shows a process 1202 that represents another overview of one manner of operation of the local system 106. In block 1204, the local system 106 successively obtains portions of model weights, at least some of the portions being downloaded from a source system (e.g., the source system 104) in a streaming operation. In block 1206, the local system successively executes parts of the machine-trained model in the local system using the portions of model weights, as the portions of model weights are successively obtained, to provide an output result. An entirety of the model weights used by the local system to provide the output result is less than an entirety of the model weights available for download at the source system.

Although not shown in a flowchart, a process performed by the source system 104 includes successively streaming portions of model weights to the local system 106 for use by the local system 106 in successively executing parts of a machine-trained model, as the portions of model weights are obtained. An entirety of the model weights used by the local system 106 to provide an output result is less than an entirety of the model weights available for download at the source system 104.

FIG. 13 shows computing equipment 1302 that, in some implementations, is used to implement the execution framework 102 of FIG. 1. The computing equipment 1302 includes a set of local devices 1304 coupled to a set of servers 1306 via a computer network 1308. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device, an Internet-of-Things (IoT) device, a gaming system, a media device, a vehicle-borne computing system, any type of robot computing system, a computing system in a manufacturing system, etc. In some implementations, the computer network 1308 is implemented as a local area network, a wide area network (e.g., the Internet), one or more point-to-point links, or any combination thereof.

The dashed-line box in FIG. 13 indicates that the functionality of the execution framework 102 is capable of being spread across the local devices 1304 and/or the servers 1306 in any manner. For instance, in some cases, one or more of the servers 1306 implement the entirety of the source system 104, and each local device, or each group of local-affiliated local devices, implements the local system 106. In one manner of use, for instance, a user may interacts with a local computing device to submit input information to the local system 106, e.g. via a browser interface of a browser program running on the local computing device. The local computing device then obtains portions of model weights from the source system 104 on an as-needed basis in the manner described above. The local computing device locally runs the machine-trained model based on the portions of model weights it obtains in piecemeal streamed fashion. In other implementations, one or more of the functions attributed to the source system 104 can be performed by a local computing device, and vice versa.

FIG. 14 shows a computing system 1402 that, in some implementations, is used to implement any aspect of the mechanisms set forth in the above-described figures. For instance, in some implementations, the type of computing system 1402 shown in FIG. 14 is used to implement any local computing device or any server shown in FIG. 13. In all cases, the computing system 1402 represents a physical and tangible processing mechanism.

The computing system 1402 includes a processing system 1404 including one or more processors. The processor(s) include one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any processor corresponds to a general-purpose processing unit or an application-specific processor unit.

The computing system 1402 also includes computer-readable storage media 1406, corresponding to one or more computer-readable media hardware units. The computer-readable storage media 1406 retains any kind of information 1408, such as machine-readable instructions, settings, model weights, and/or other data. For example, in some implementations, the computer-readable storage media 1406 includes one or more solid-state devices, one or more magnetic hard disks, one or more optical disks, magnetic tape, etc. Any instance of the computer-readable storage media 1406 uses any technology for storing and retrieving information. Further, any instance of the computer-readable storage media 1406 represents a fixed or removable unit of the computing system 1402. Further, any instance of the computer-readable storage media 1406 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; the computer-readable storage medium may be considered “non-transitory” in this regard.

The computing system 1402 utilizes any instance of the computer-readable storage media 1406 in different ways. For example, in some implementations, any instance of the computer-readable storage media 1406 represents a hardware memory unit (such as random access memory (RAM)) for storing information during execution of a program by the computing system 1402, and/or a hardware storage unit (such as a hard disk) for retaining/archiving information on a more permanent basis. In the latter case, the computing system 1402 also includes one or more drive mechanisms 1410 (such as a hard drive mechanism) for storing and retrieving information from an instance of the computer-readable storage media 1406.

In some implementations, the computing system 1402 performs any of the functions described above when the processing system 1404 executes computer-readable instructions stored in any instance of the computer-readable storage media 1406. For instance, in some implementations, the computing system 1402 carries out computer-readable instructions to perform each block of the processes described in with reference to FIGS. 11 and 12. FIG. 14 generally indicates that hardware logic circuitry 1412 includes any combination of the processing system 1404 and the computer-readable storage media 1406.

In addition, or alternatively, the processing system 1404 includes one or more other configurable logic units that perform operations using a collection of logic gates. For instance, in some implementations, the processing system 1404 includes a fixed configuration of hardware logic gates, e.g., that are created and set at the time of manufacture, and thereafter unalterable. In addition, or alternatively, the processing system 1404 includes a collection of programmable hardware logic gates that are set to perform different application-specific tasks. The latter category of devices includes, including Programmable Array Logic Devices (PALs), Generic Array Logic Devices (GALs), Complex Programmable Logic Devices (CPLDs), Field-Programmable Gate Arrays (FPGAs), etc. In these implementations, the processing system 1404 effectively incorporates a storage device that stores computer-readable instructions, insofar as the configurable logic units are configured to execute the instructions and therefore embody or store these instructions.

In some cases (e.g., in the case in which the computing system 1402 represents a user computing device), the computing system 1402 also includes an input/output interface 1414 for receiving various inputs (via input devices 1416), and for providing various outputs (via output devices 1418). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1420 and an associated graphical user interface presentation (GUI) 1422. The display device 1420 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1402 also includes one or more network interfaces 1424 for exchanging data with other devices via one or more communication conduits 1426. One or more communication buses 1428 communicatively couple the above-described units together.

The communication conduit(s) 1426 is capable of being be implemented in any manner, e.g., by a local area computer network, a wide area computer network (e.g., the Internet), point-to-point connections, or any combination thereof. The communication conduit(s) 1426 include any combination of hardwired links, wireless links, routers, gateway functionality, name servers, etc., governed by any protocol or combination of protocols.

FIG. 14 shows the computing system 1402 as being composed of a discrete collection of separate units. In some cases, the collection of units corresponds to discrete hardware units provided in a computing device chassis having any form factor. FIG. 14 shows illustrative form factors in its bottom portion. In other cases, the computing system 1402 includes a hardware logic unit that integrates the functions of two or more of the units shown in FIG. 1. For instance, in some implementations, the computing system 1402 includes a system on a chip (SoC or SOC), corresponding to an integrated circuit that combines the functions of two or more of the units shown in FIG. 14.

The following summary provides a set of illustrative examples of the technology set forth herein.

(A1) According to a first aspect, a computer-implemented method (e.g., 1202) is described for executing a machine-trained model in a local system (e.g., 106). The method includes: successively obtaining (e.g., 1204) portions of model weights, at least some of the portions being downloaded from a source system (e.g., 104) in a streaming operation; and successively executing (1204) parts of the machine-trained model in the local system using the portions of model weights, as the portions of model weights are successively obtained, to provide an output result. The entirety of the model weights used by the local system to provide the output result is less than an entirety of the model weights available for download at the source system.

(A2) According to some implementations of the method of A1, the portions of model weights available at the source system are expressible as a hierarchical tree, and the entirety of the model weights used to provide the output result corresponds to part of the hierarchical tree that is less than an entirety of the hierarchical tree.

(A3) According to some implementations of the methods of A1 or A2, for at least some of the portions of model weights, each portion of model weights includes transformation weights and decision weights.

(A4) According to some implementations of the method of A3, executing a particular part of the machine-trained model, associated with particular transformation weights and particular decision weights, includes: mapping input embedding information to output embedding information using the particular transformation weights; and deciding a next model part of the machine-trained model to execute based on the output embedding information and the particular decision weights.

(A5) According to some implementations of the method of A4, the mapping involves a transformer-based operation that uses an attention mechanism.

(A6) According to some implementations of the method of A4, the particular decision weights include first decision weights and second decision weights. The deciding includes: generating a first result based on the output embedding information and the first decision weights; generating a second result based on the output embedding information and the decision weights; and choosing a routing path based on the first result and the second result, the routing path leading to the next model part.

(A7) According to some implementations of the method of A6, the choosing involves assigning each routing path that was not chosen a probability of zero.

(A8) According to some implementations of the method of A6, the choosing involves assigning at least two routing paths non-zero probabilities, the routing path that is chosen having a highest probability.

(A9) According to some implementations of the method of A6, the choosing chooses among three or more routing paths that lead to three or more respective model parts.

(A10) According to some implementations of the method of A6, the method further includes executing the next model part, wherein the output embedding information is used as new input embedding information.

(A11) According to some implementations of any individual method of A1-A10, at least one part of the machine-trained model is a local part that relies on a locally-stored portion of weights provided in a local store of the local system, prior to a request to obtain the locally-stored portion of weights.

(A12) According to some implementations of the method of A11, the local system includes a local computing device that stores all local parts.

(A13) According to some implementations of the method of A11, the local system includes a first local computing device that stores some of local parts, and a second local computing device that stores other of the local parts.

(A14) According to some implementations of the method of A11, a particular model part is designated as a local part if a frequency of use of the particular model part satisfies a prescribed threshold value, and/or the particular model part has a particular position in a hierarchy of model parts of the machine-trained model.

(B1) According to a second aspect, another computer-implemented method is described for facilitating the execution of a machine-trained model. The method includes using a download controller (e.g., 114) to successively stream portions of model weights provided in a system store (e.g., 110) to a local system (106) for use in successively executing parts of the machine-trained model at the local system, as the portions of model weights are obtained. An entirety of the model weights used by the local system to provide an output result is less than an entirety of the model weights available for download at a source system (e.g., 104).

(C1) According to a second aspect, another computer-implemented method (e.g., 1102) is described for executing a machine-trained model in a local system (e.g., 106). The method includes: receiving (e.g., 1104) a particular portion of model weights from a source system (e.g., 104), the particular portion being associated with a particular part of a machine-trained model and including particular transformation weights and particular decision weights; mapping (e.g., 1106) input embedding information to output embedding information using the particular transformation weights; deciding (e.g., 1108) a next model part to execute based on the output embedding information and the particular decision weights; and receiving (e.g., 1110) a next portion of model weights, corresponding to the next model part of the machine-trained model, from the source system, the next portion including next transformation weights and next decision weights.

In yet another aspect, some implementations of the technology described herein include a computing system (e.g., the computing system 1402) that includes a processing system (e.g., the processing system 1404) having a processor. The computing system also includes a storage device (e.g., the computer-readable storage media 1406) for storing computer-readable instructions (e.g., information 1408). The processing system executes by the machine-readable instructions to perform any of the methods described herein (e.g., any individual method of the methods of A1-A14, B1, or C1).

In yet another aspect, some implementations of the technology described herein include a computer-readable storage medium (e.g., the computer-readable storage media 1406) for storing computer-readable instructions (e.g., the information 1408). A processing system (e.g., the processing system 1404) executes the computer-readable instructions to perform any of the operations described herein (e.g., the operation in any individual method of the methods of A1-A14, B1, or C1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuitry 1412 of FIG. 14. The term “logic” likewise encompasses various physical and tangible mechanisms for performing a task. For instance, each processing-related operation illustrated in the flowcharts of FIGS. 11 and 12 corresponds to a logic component for performing that operation.

This description may have identified one or more features as “optional.” This type of statement is not to be interpreted as an exhaustive indication of features that are to be considered optional; generally, any feature is to be considered as optional, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. Further, the terms “comprising,” “including,” and “having” are open-ended terms that are used to identify at least one part of a larger whole, but not necessarily all parts of the whole. A “set” includes zero members, one member, or more than one member. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for executing a machine-trained model in a local system, comprising:
successively obtaining portions of model weights, at least some of the portions being downloaded from a source system in a streaming operation; and
successively executing parts of the machine-trained model in the local system using the portions of model weights, as the portions of model weights are successively obtained, to provide an output result,
an entirety of the model weights used by the local system to provide the output result being less than an entirety of the model weights available for download at the source system.

2. The method of claim 1, wherein the portions of model weights available at the source system are expressible as a hierarchical tree, and the entirety of the model weights used to provide the output result corresponds to part of the hierarchical tree that is less than an entirety of the hierarchical tree.

3. The method of claim 1, wherein, for at least some of the portions of model weights, each portion of model weights includes transformation weights and decision weights.

4. The method of claim of claim 3, wherein executing a particular part of the machine-trained model, associated with particular transformation weights and particular decision weights, includes:
mapping input embedding information to output embedding information using the particular transformation weights; and
deciding a next model part of the machine-trained model to execute based on the output embedding information and the particular decision weights.

5. The method of claim 4, wherein the mapping involves a transformer-based operation that uses an attention mechanism.

6. The method of claim 4,
wherein the particular decision weights include first decision weights and second decision weights,
and wherein the deciding includes:
generating a first result based on the output embedding information and the first decision weights;
generating a second result based on the output embedding information and the decision weights; and
choosing a routing path based on the first result and the second result, the routing path leading to the next model part.

7. The method of claim 6, wherein the choosing involves assigning each routing path that was not chosen a probability of zero.

8. The method of claim 6, wherein the choosing involves assigning at least two routing paths non-zero probabilities, the routing path that is chosen having a highest probability.

9. The method of claim 6, wherein the choosing chooses among three or more routing paths that lead to three or more respective model parts.

10. The method of claim 6, further including executing the next model part, wherein the output embedding information is used as new input embedding information.

11. The method of claim 1, wherein at least one part of the machine-trained model is a local part that relies on a locally-stored portion of weights provided in a local store of the local system, prior to a request to obtain the locally-stored portion of weights.

12. The method of claim 11, wherein the local system includes a local computing device that stores all local parts.

13. The method of claim 11, wherein the local system includes a first local computing device that stores some of local parts, and a second local computing device that stores other of the local parts.

14. The method of claim 11, wherein a particular model part is designated as a local part if a frequency of use of the particular model part satisfies a prescribed threshold value, and/or the particular model part has a particular position in a hierarchy of model parts of the machine-trained model.

15. A computer-implemented source system, comprising:
a system store that provides model weights used by a machine-trained model; and
a download controller for successively streaming portions of the model weights to a local system for use in successively executing parts of the machine-trained model at the local system, as the portions of model weights are obtained,
an entirety of the model weights used by the local system to provide an output result being less than an entirety of the model weights available for download at the source system.

16. The computer-implemented source system of claim 15, wherein the portions of model weights available at the source system are expressible as a hierarchical tree, and the entirety of the model weights used to provide the output result corresponds to part of the hierarchical tree that is less than an entirety of the hierarchical tree.

17. The computer-implemented source system of claim 15, wherein, for at least some of the portions of model weights, each portion of model weights includes transformation weights and decision weights.

18. A computer-readable storage medium for storing computer-readable instructions, a processing system executing the computer-readable instructions to perform operations comprising:
receiving a particular portion of model weights from a source system, the particular portion being associated with a particular part of a machine-trained model and including particular transformation weights and particular decision weights;
mapping input embedding information to output embedding information using the particular transformation weights;
deciding a next model part to execute based on the output embedding information and the particular decision weights; and
receiving a next portion of model weights, corresponding to the next model part of the machine-trained model, from the source system, the next portion including next transformation weights and next decision weights.

19. The computer-readable storage medium of claim 18, wherein the mapping involves a transformer-based operation.

20. The computer-readable storage medium of claim 18,
wherein the particular decision weights include first decision weights and second decision weights, and
wherein the deciding includes:
generating a first result based on the output embedding information and the first decision weights;
generating a second result based on the output embedding information and the decision weights; and
choosing a routing path based on the first result and the second result, the routing path leading to the next model part.
